(19) United States
(12) Patent Application Publication
(10) Pub. No.: US 2020/0309532 A1
(43) Pub. Date: Oct. 1, 2020

(54) ROUTE SEARCH APPARATUS

(71) Applicant: TOSHIBA TEC KABUSHIKI KAISHA, Tokyo (JP)

(72) Inventor: Fumiko Motoki, Yokohama Kanagawa (JP)

(21) Appl. No.: 16/720,264

(22) Filed: Dec. 19, 2019

(30) Foreign Application Priority Data
Mar. 25, 2019 (JP) 2019-056318

(51) Int. Cl. G01C 21/20; G06Q 30/06; H04W 4/33; H04W 4/024; G08B 21/18

(52) U.S. Cl. CPC G01C 21/206; G06Q 30/0639; G06N 5/04; H04W 4/024; G08B 21/182; H04W 4/33

(57) ABSTRACT

According to one embodiment, a route search apparatus includes a store search unit and a route generation unit. The store search unit searches for a store matching a purpose by setting the purpose of a user in a commercial facility and a plurality of conditions related to the purpose as input data, and by setting a business type or a business category of each store opening in the commercial facility as reference data. The route generation unit generates a guide route for going around the store within a scheduled stay time by setting the store searched for by the store search unit and the scheduled stay time of the user in the commercial facility as input data, and by setting a layout of the commercial facility and an estimated stay time at the store as reference data.

### CROSS-REFERENCE TO RELATED APPLICATION

This application is based upon and claims the benefit of priority from Japanese Patent Application No. 2019-056318, filed on Mar. 25, 2019, the entire contents of which are incorporated herein by reference.

### FIELD

Embodiments described herein relate generally to a route search apparatus.

### BACKGROUND

In the related art, as a route search apparatus in a commercial facility, a route search apparatus capable of providing information on the order of going around a store or a sales floor with high efficiency when a customer purchases a plurality of commodities is already known. The route search apparatus in the related art is effective when a commodity to be purchased is determined.

### DESCRIPTION OF THE DRAWINGS

FIG. 1 is a schematic diagram illustrating a system configuration of a first embodiment;

FIG. 2 is a block diagram illustrating a schematic configuration of a store entry and exit detection system;

FIG. 3 is a flowchart illustrating an operation procedure of a control apparatus;

FIG. 4 is a schematic diagram illustrating a main data structure of a store management record;

FIG. 5 is a schematic diagram illustrating a main data structure of a user management record;

FIG. 6 is a schematic diagram illustrating a main data structure of a route management record;

FIG. 7 is a schematic diagram illustrating a data structure of a guide route;

FIG. 8 is a block diagram illustrating a main circuit configuration of a route search server;

FIG. 9 is a schematic diagram illustrating a functional configuration of a store search unit;

FIG. 10 is a schematic diagram illustrating a functional configuration of a route search unit;

FIG. 11 is a flowchart illustrating a procedure of main information processing executed by a processor of the route search server;

FIG. 12 is a flowchart illustrating a specific procedure of reception processing;

FIG. 13 is a flowchart illustrating a specific procedure of store entry processing;

FIG. 14 is a flowchart illustrating a specific procedure of store exit processing;

FIG. 15 is a flowchart illustrating a specific procedure of store exit processing;

FIG. 16 is a flowchart illustrating a specific procedure of end processing;

FIG. 17 is a schematic diagram illustrating a system configuration of a second embodiment; and

FIG. 18 is a flowchart illustrating apart of a procedure of store exiting processing.

### DETAILED DESCRIPTION

An embodiment provides a route search apparatus capable of searching for a highly efficient route from the purpose of a customer visiting a commercial facility even when a commodity to be purchased is not determined.

In general, according to one embodiment, a route search apparatus includes a store search unit and a route generation unit. The store search unit searches for a store matching a purpose by setting the purpose of a user in a commercial facility and a plurality of conditions related to the purpose as input data, and by setting a business type or a business category of each store opening in the commercial facility as reference data. The route generation unit generates a guide route for going around the store within a scheduled stay time by setting the store searched by the store search unit and the scheduled stay time of the user in the commercial facility as input data, and by setting a layout of the commercial facility and an estimated stay time at the store as reference data.

Hereinafter, an embodiment of a route search apparatus capable of searching for a highly efficient route from the purpose of a customer visiting a commercial facility even when a commodity to be purchased is not determined will be described with reference to the accompanying drawings.

First, in the embodiment, the concept of a commercial facility can include not only a commercial facility such as a department store and a shopping center, but also a commercial area such as a shopping street and a shopping mall. Further, the concept of a store can include not only a store opening as a retail business in the shopping center, the shopping street, and the shopping mall, but also a sales floor for each business type developed in the commercial facility such as the department store.

### First Embodiment

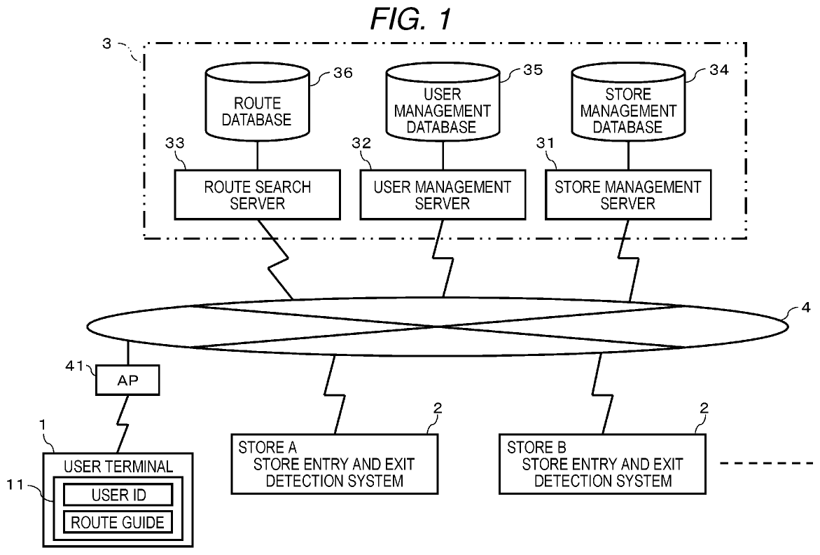

FIG. 1 is a schematic diagram illustrating a system configuration of a first embodiment. The first embodiment is configured with a user terminal 1, a store entry and exit detection system 2 for each store, a server system 3 for performing a route guide service, and a network 4. The network 4 is, typically, the Internet or the Internet virtual private network (VPN). The network 4 may include a mobile communication network. An access point 41 capable of performing wireless communication with the user terminal 1 is connected to the network 4. The access point 41 is disposed at an entrance and exit of a commercial facility and in the commercial facility or a passage leading to the commercial facility.

The user terminal 1 is carried and used by a facility user who receives a route guide service in the commercial facility, a so-called customer. The user terminal 1 is a portable-type information terminal that includes a display device and an input device and on which a wireless unit is mounted. The display device and the input device may be respectively separate devices, or may be an integrated device such as a touch panel. As this type of the user terminal 1, for example, a smartphone, a tablet terminal, and a notebook type personal computer are used.

A memory 11 of the user terminal 1 stores a user ID and a route guide program. The user ID is a unique code set for each user terminal 1 in order to individually identify the user terminal 1. The user ID may be a member code assigned to each customer using the user terminal 1, and may be a telephone number.

The route guide program is software for receiving the route guide service in the commercial facility. A customer can receive the route guide service from the server system 3 by installing the route guide program in the user terminal 1. A method for installing the route guide program in the user terminal 1 is not particularly limited. A method in the related art for installing software in an information terminal such as a smartphone can be used as it is.

When a customer visiting the commercial facility receives the route guide service, first, the user terminal 1 is operated to activate the route guide program. When the route guide program is activated, a data signal including the user ID is periodically transmitted in the user terminal 1. When the data signal is received by the access point 41, the user terminal 1 is connected to the network 4 and a communication line with the server system 3 is established. By establishing the communication line with the server system 3, the user terminal 1 can perform route search in response to the purpose of the customer who is a user.

The store entry and exit detection system 2 is a system for detecting the store entry and the store exit of the customer carrying the user terminal 1 in which the route guide program is activated, and is respectively provided at each store opening in the commercial facility. The store entry and exit detection system 2 is connected to the network 4 via wired communication or wireless communication.

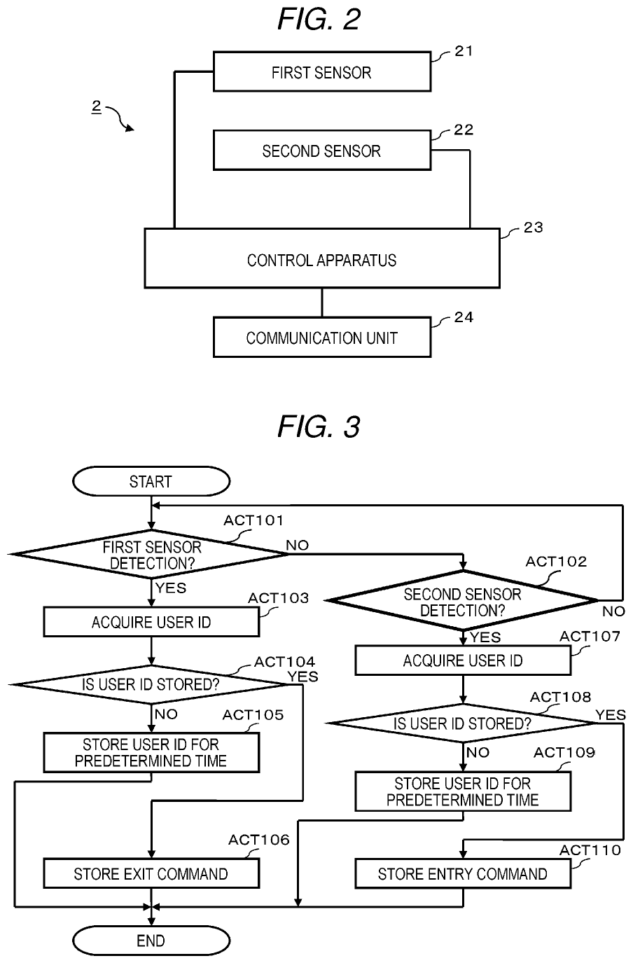

FIG. 2 is a block diagram illustrating a schematic configuration of the store entry and exit detection system 2. As illustrated in FIG. 2, the store entry and exit detection system 2 includes a first sensor 21, a second sensor 22, a control apparatus 23, and a communication unit 24. Both the first sensor 21 and the second sensor 22 are devices capable of receiving the data signal of the user ID transmitted from the user terminal 1. When receiving the data signal of the user ID with a radio wave intensity equal to or higher than a fixed level, the first sensor 21 and the second sensor 22 output a detection signal including the user ID to the control apparatus 23.

The first sensor 21 is provided in the vicinity of the entrance and exit so that the data signal transmitted from the user terminal 1 of the customer passing through the entrance and exit of the store can be received with the radio wave intensity equal to or higher than the fixed level. The second sensor 22 is provided inside the store more than the first sensor 21 so that the data signal transmitted from the user terminal 1 of the customer entering the store through the entrance and exit can be received with the radio wave intensity equal to or higher than the fixed level. Therefore, when the customer carrying the user terminal 1 enters the store through the entrance and exit, the data signal transmitted from the user terminal 1 is first received by the first sensor 21 and then received by the second sensor 22. On the other hand, when the customer exits the store through the entrance and exit, the data signal of the user terminal 1 carried by the customer is first received by the second sensor 22 and then received by the first sensor 21.

When receiving the data signal with the radio wave intensity equal to or higher than the fixed level, the first sensor 21 outputs the detection signal to the control apparatus 23. The detection signal includes the user ID obtained from the data signal received by the first sensor 21. When receiving the data signal with the radio wave intensity equal to or higher than the fixed level, the second sensor 22 outputs the detection signal to the control apparatus 23. The detection signal includes the user ID obtained from the data signal received by the second sensor 22.

FIG. 3 is a flowchart illustrating an operation procedure of the control apparatus 23. As illustrated in FIG. 3, the control apparatus 23 confirms whether or not the detection signal is received from the first sensor 21 as ACT 101. When the detection signal is not received therefrom, the control apparatus 23 determines NO in ACT 101 and proceeds to ACT 102. The control apparatus 23 confirms whether or not the detection signal is received from the second sensor 22 as ACT 102. When the detection signal is not received therefrom, the control apparatus 23 determines NO in ACT 102 and returns to ACT 101. Here, the control apparatus 23 waits for receiving the detection signal from the first sensor 21 or receiving the detection signal from the second sensor 22 in ACT 101 and ACT 102.

In a standby state of ACT 101 and ACT 102, when receiving the detection signal from the first sensor 21, the control apparatus 23 determines YES in ACT 101 and proceeds to ACT 103. The control apparatus 23 acquires the user ID from the detection signal as ACT 103. Next, the control apparatus 23 confirms whether or not the same user ID as the user ID acquired from the detection signal is stored in the memory in the control apparatus 23 as ACT 104. When the same user ID is not stored therein, the control apparatus 23 determines NO in ACT 104 and proceeds to ACT 105. The control apparatus 23 stores the user ID acquired from the detection signal in the memory for a predetermined time as ACT 105. Here, the predetermined time is a time longer than the time required for the customer entering the store through the entrance and exit to pass through a detection area of the first sensor 21 and then pass through a detection area of the second sensor 22, for example, 10 seconds.

When the same user ID as the user ID acquired from the detection signal is stored in the memory, the control apparatus 23 determines YES in ACT 104 and proceeds to ACT 106. The control apparatus 23 controls the communication unit 24 so as to output a store exit command as ACT 106. By this control, the communication unit 24 outputs the store exit command to the server system 3 via the network 4. The store exit command includes the user ID acquired by the processing of ACT 103.

In the standby state of ACT 101 and ACT 102, when receiving the detection signal from the second sensor 22, the control apparatus 23 determines YES in ACT 102 and proceeds to ACT 107. The control apparatus 23 acquires the user ID from the detection signal as ACT 107. Next, the control apparatus 23 confirms whether or not the same user ID as the user ID acquired from the detection signal is stored in the memory in the control apparatus 23 as ACT 108. When the same user ID is not stored therein, the control apparatus 23 determines NO in ACT 108 and proceeds to ACT 109. The control apparatus 23 stores the user ID received from the detection signal in the memory for a predetermined time as ACT 109. Here, the predetermined time is a time longer than the time required for the customer exiting the store through the entrance and exit to pass through the detection area of the second sensor 22 and then pass through the detection area of the first sensor 21, for example, 10 seconds.

When the same user ID as the user ID included in the detection signal is stored in the memory, the control apparatus 23 determines YES in ACT 108 and proceeds to ACT 110. The control apparatus 23 controls the communication unit 24 so as to output a store entry command as ACT 110. By this control, the communication unit 24 outputs the store entry command to the server system 3 via the network 4. The store entry command includes the user ID acquired by the processing of ACT 107.

As described above, the control apparatus 23 detects the store entry or the store exit of the customer based upon the detection signals from the first sensor 21 and the second sensor 22. That is, when the control apparatus 23 receives the detection signal including the user ID from the first sensor 21, stores the user ID in the memory, and then receives the detection signal including the same user ID from the second sensor 22 within the predetermined time, the control apparatus 23 detects that the customer identified by the user ID enters the store. Next, the control apparatus 23 controls the communication unit 24 so as to output the store entry command to the server system 3. Further, when the control apparatus 23 receives the detection signal including the user ID from the second sensor 22, stores the user ID in the memory, and then receives the detection signal including the same user ID from the first sensor 21 within the predetermined time, the control apparatus 23 detects that the customer identified by the user ID exits the store. Next, the control apparatus 23 controls the communication unit 24 so as to output the store exit command to the server system 3.

Under the control of the control apparatus 23, the communication unit 24 performs data communication with the server system 3 connected to the network 4 according to a predetermined communication protocol, and transmits the store entry command or the store exit command. The store entry command or the store exit command includes the user ID of the detection signal received from the first sensor 21 or the second sensor 22.

Further, in the case of a store where the entrance and the exit are distinguished, the first sensor 21 may be provided at the entrance and the second sensor 22 may be provided at the exit. In this case, the control apparatus 23 detects the store entry of the customer based upon the detection signal from the first sensor 21, and detects the store exit of the customer based upon the detection signal from the second sensor 22. As described above, the communication unit 24 transmits the store entry command or the store exit command.

Refer back to the description of FIG. 1.

The server system 3 includes a store management server 31, a user management server 32, and a route search server 33. The store management server 31, the user management server 32, and the route search server 33 are respectively connected to the network 4.

The store management server 31 is a computer for a server specialized in data management of each store opening in the commercial facility. The store management server 31 includes a store management database 34. The store management database 34 may be formed in a storage apparatus incorporated in the store management server 31, or may be formed in a storage apparatus connected to the outside of the store management server 31.

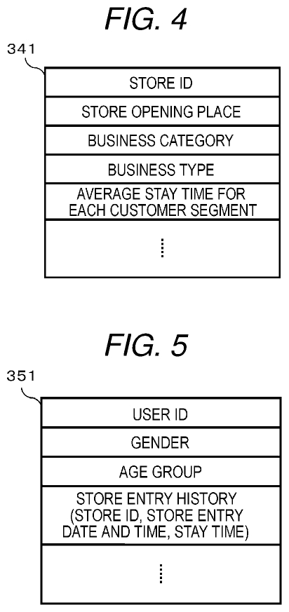

The store management database 34 stores a store management record 341 (refer to FIG. 4). The store management record 341 is generated for each store opening in the commercial facility, and is stored in the store management database 34. A main data structure of the store management record 341 is represented by a schematic diagram of FIG. 4. As illustrated in FIG. 4, the store management record 341 includes data items such as a store ID, a store opening place, a business category, a business type, and an average stay time for each customer segment.

The store ID is a unique code assigned to each store in order to individually identify each store opening in the commercial facility. The store opening place is a location of the store on map data illustrating the layout of each store and a common facility constituting the commercial facility. The business category is an item that classifies each store according to a sales method and a management policy. The business type is an item that classifies each store according to the type of available commodities. The average stay time for each customer segment is an average value of the stay time from entering the store to exiting the store for each customer segment classified by a gender and an age group. The average stay time for each customer segment is calculated based upon the average stay time for many customer segments accumulated in the past, and is incorporated in the store management record 341.

The user management server 32 is a computer for a server specialized in the data management of a customer who is a user. The user management server 32 includes a user management database 35. The user management database 35 may be formed in a storage apparatus incorporated in the user management server 32 or may be formed in a storage apparatus connected to the outside of the user management server 32.

The user management database 35 stores a user management record 351 (refer to FIG. 5). The user management record 351 is generated for each customer who installs the route guide program in the user terminal 1. A main data structure of the user management record 351 is represented by a schematic diagram of FIG. 5. As illustrated in FIG. 5, the user management record 351 includes data items such as a user ID, a gender, an age group, and a store entry history. The store entry history is data indicating a history of a customer entering the store in the commercial facility. Each time the customer enters the store, the store entry history is generated and added to the user management record 351. The store entry history includes a store ID, a store entry date and time, and a stay time. The data of the store entry history of each user are used for calculating the above-described average stay time for each customer segment.

The route search server 33 is a computer for a server specialized in searching for a highly efficient route from the purpose of a customer visiting a commercial facility and the condition thereof. That is, the route search server 33 is one aspect of the route search apparatus. The route search server 33 includes a route database 36. The route database 36 may be formed in a storage apparatus incorporated in the route search server 33, or may be formed in a storage apparatus connected to the outside of the route search server 33.

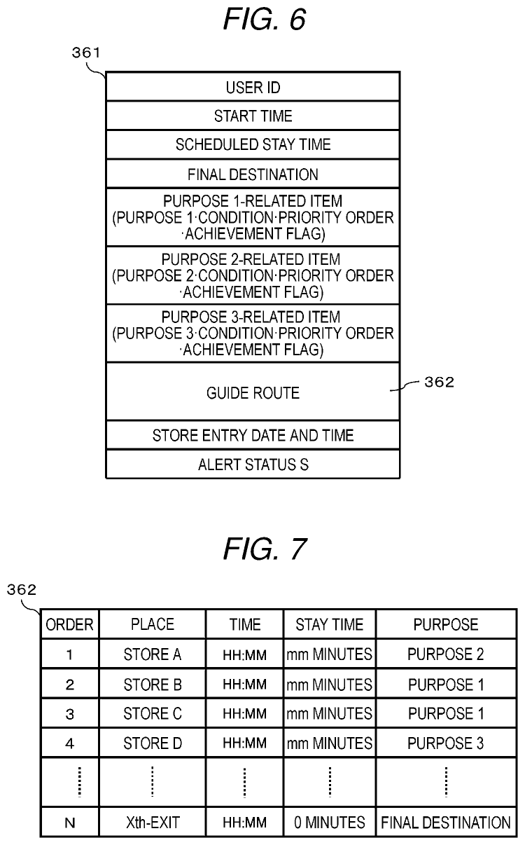

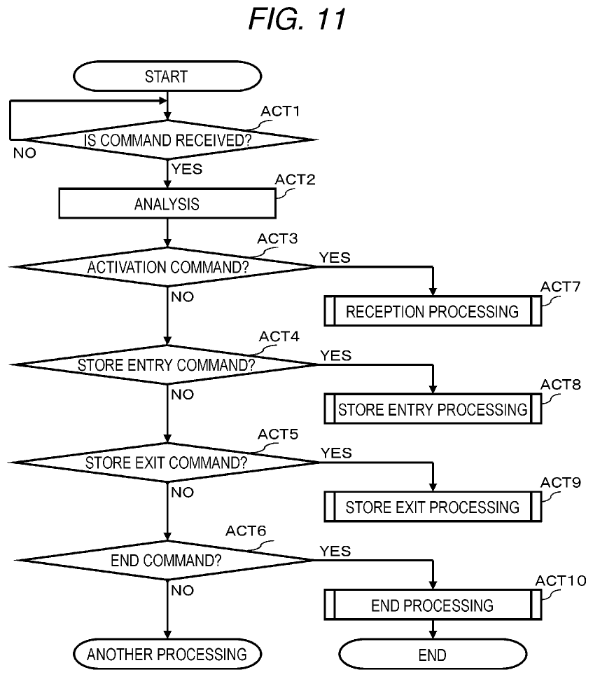

The route database 36 stores a route management record 361 (refer to FIG. 6). The route management record 361 is generated for each customer who receives the route guide service. A main data structure of the route management record 361 is represented by a schematic diagram of FIG. 6. As illustrated in FIG. 6, the route management record 361 includes data items such as a user ID, a start time, a scheduled stay time, a final destination, a related item for each purpose, a guide route 362, a store entry date and time, and an alert status S. Among the data items, the store entry date and time and the alert status S will be clarified in the descriptions of flowcharts of FIGS. 11 to 15 which will be described later.

The start time is the time when the route search is started. The scheduled stay time is the time that the customer is scheduled to stay in the commercial facility. The final destination is a place in the commercial facility to which a customer who reaches the scheduled stay time goes. For example, common facilities such as a parking lot, a passage leading to a transportation facility, a taxi stand, and a place where a symbol or an object is installed can be the final destination.

The related item for each purpose records a condition related to the purpose, priority order, and an achievement flag for each purpose of the customer visiting the commercial facility. The condition is not limited to one condition. There may be a plurality of conditions. The priority order is the order of priority set for each purpose when there are a plurality of purposes. The priority order is set by the customer himself or herself. The achievement flag is 1-bit data for identifying whether or not the purpose is achieved. Whether or not the purpose is achieved is determined by the customer himself or herself. In the embodiment, when the purpose is not achieved, the achievement flag is set to “0”, and when the purpose is achieved, the achievement flag is set to “1”.

For example, the purpose of the customer visiting the commercial facility is a purpose accompanied by the purchase of a commodity such as “I want to buy a present for Father's Day” and “I want to buy a spring clothing item”. In addition, for example, there is a purpose which is not accompanied by the purchase of the commodity such as “I want to enjoy window shopping” or “I want to eat delicious food”. A condition related to the purpose of “I want to buy a present for Father's Day” includes an age, a hobby, and a preference of farther. A condition related to the purpose of “I want to buy a spring clothing item” includes a gender, an age, a body shape, and a preference of a related person. A condition related to the purpose of “I want to enjoy window shopping” includes a gender, an age, a hobby, and a preference of a person himself or herself. A condition related to the purpose of “I want to eat delicious food” includes a gender, an age, and a preference of a person himself or herself, and a business type and a business category of a restaurant.

The guide route 362 is data indicating a highly efficient route for the customer identified by the user ID to achieve the purpose specified by the related item for each purpose and to head toward the final destination within the scheduled stay time from the start time in the commercial facility.

FIG. 7 is a schematic diagram illustrating a data structure of the guide route 362. As illustrated in FIG. 7, the guide route 362 is table-like data describing a place, a time, a stay time, and a purpose for each guide order. The place is information on a store where the purpose can be achieved or a final destination. The store information includes the store ID. The time is the time at which the store or the final destination is scheduled to be reached. The stay time is an estimated stay time to be estimated that the customer stays at the store. The purpose is data representing a purpose that can be achieved at the store. The data of the guide route 362 are generated in such a manner that the store management record 341 of the store management database 34 and the user management record 351 of the user management database 35 are appropriately referred to based upon each piece of data of the start time, the scheduled stay time, the final destination, and the related item for each purpose of the route management record 361 in the route search server 33.

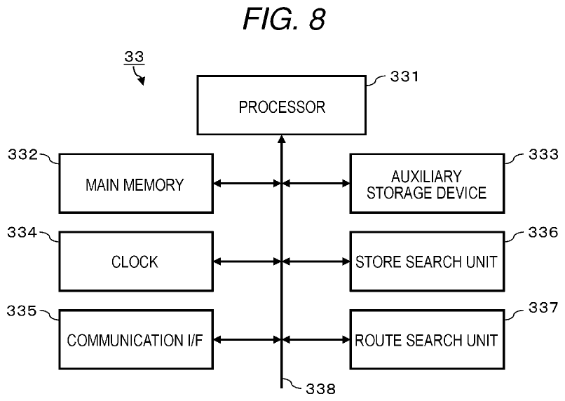

FIG. 8 is a block diagram illustrating a main circuit configuration of the route search server 33. The route search server 33 includes a processor 331, a main memory 332, an auxiliary storage device 333, a clock 334, a communication interface 335, a store search unit 336, a route search unit 337, and a system transmission line 338. The system transmission line 338 includes an address bus, a data bus, and a control signal line. The system transmission line 338 connects the processor 331, the main memory 332, the auxiliary storage device 333, the clock 334, the communication interface 335, the store search unit 336, and the route search unit 337 to each other. The processor 331, the main memory 332, and the auxiliary storage device 333 are connected to each other by the system transmission line 338, thereby forming a computer of the route search server 33.

The processor 331 corresponds to a central part of the computer. The processor 331 controls each unit to implement various functions as the route search server 33 according to an operating system or an application program. The processor 331 is, for example, a central processing unit (CPU).

The main memory 332 corresponds to a main storage part of the computer. The main memory 332 includes a non-volatile memory area and a volatile memory area. The main memory 332 stores the operating system or the application program in the non-volatile memory area. The main memory 332 may store data that are necessary for the processor 331 to execute processing for controlling each unit in the non-volatile or volatile memory area. The main memory 332 uses the volatile memory area as a work area in which data are appropriately rewritten by the processor 331. The non-volatile memory area is, for example, a read only memory (ROM). The volatile memory area is, for example, a random access memory (RAM).

The auxiliary storage device 333 corresponds to an auxiliary storage part of the computer. For example, an electric erasable programmable read-only memory (EEPROM) and a hard disk drive (HDD), or a solid state drive (SSD) can be used as the auxiliary storage device 333. The auxiliary storage device 333 stores data used for the processor 331 to perform various processing, and data generated by the processing of the processor 331. The auxiliary storage device 333 may store the aforementioned application program.

The application program stored in the main memory 332 or the auxiliary storage device 333 includes a control program described regarding information processing to be executed by the route search server 33. A method for installing the control program in the main memory 332 or the auxiliary storage device 333 is not particularly limited. A registration program is recorded in a removable recording medium, or the control program is distributed by communication via a network, thereby making it possible to install the control program in the main memory 332 or the auxiliary storage device 333. The form of the recording medium does not matter as long as the recording medium can store a program that can be read by an apparatus, such as a CD-ROM and a memory card.

The clock 334 is a time information source of the route search server 33. The processor 331 processes the time counted by the clock 334 as a current time.

The communication interface 335 performs data communication with a device connected via the network 4 according to a predetermined communication protocol.

The store search unit 336 is a data processing unit specialized in searching for a store which is recommended as being able to achieve the purpose for each purpose of the customer visiting the commercial facility. The route search unit 337 is a data processing unit specialized in searching for a route for going around the store searched by the store search unit 336. Both the store search unit 336 and the route search unit 337 are realized by software using artificial intelligence (AI).

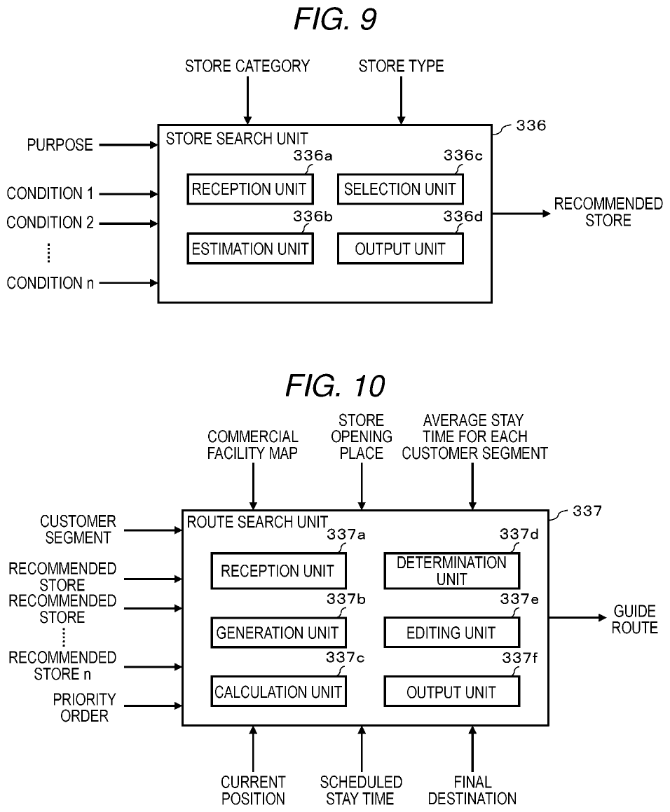

Specifically, as illustrated in FIG. 9, the store search unit 336 includes a reception unit 336a, an estimation unit 336b, a selection unit 336c, and an output unit 336d. The reception unit 336a receives the purpose of visiting the commercial facility of the customer and n conditions related to the purpose as input data to the store search unit 336. Further, “n” is an integer of 1 or greater.

The estimation unit 336b similarly estimates the business type or the business category of a store matching the purpose of receiving the input on the condition that the input is received by the reception unit 336a. For this estimation, the purpose and condition are set as input data and the business type or business category is set as output data, and a prediction model for estimating the output corresponding to the input is used. When the purpose is a purpose accompanied by the purchase of the commodity, the business type or business category of a store selling or providing a commodity that can achieve the purpose on the condition related to the purpose is inevitably determined. Further, even when the purpose is not accompanied by the purchase of the commodity, the business type or business category of the store that can achieve the purpose on the condition related to the purpose is inevitably determined. Therefore, the above-described prediction model can be generated by using a general-purpose machine learning algorithm with the purpose, the condition, the business type, and the business category which are correlated with one another as teacher data respectively.

The selection unit 336c selects the store of the business type or business category estimated by the estimation unit 336b by using the store management record 341 as reference data. When a plurality of corresponding stores exists, the selection unit 336c collectively selects the stores. The output unit 336d outputs the store ID of the store selected by the selection unit 336c to the route search unit 337 as store identification data of the recommended store.

As illustrated in FIG. 10, the route search unit 337 includes a reception unit 337a, a generation unit 337b, a calculation unit 337c, a determination unit 337d, an editing unit 337e, and an output unit 337f. The receiving unit 337a receives the store identification data of n recommended stores outputted from the store search unit 336. Further, “n” is an integer of 1 or greater.

The generation unit 337b generates the guide route 362 for going around the recommended stores identified by the store identification data received by the reception unit 337a. When generating the guide route 362, the generation unit 337b refers to the map data of the commercial facility, the store opening place of each recommended store, the current location of the customer, and the final destination. The map data are data indicating the layout of each store and the common facility constituting the commercial facility in a plane rectangular coordinate system. The map data are stored in the auxiliary storage device 333. The store opening place of each store is obtained from the store management record 341. The current location of the customer is specified by a position of the access point 41 receiving the data signal from the user terminal 1. The position data of each access point 41 are set in the auxiliary storage device 333 in advance. The final destination is obtained from the user management record 351. The generation unit 337b generates the guide route 362 from the current position to the final destination through each store according to a rule that a travel distance becomes minimum.

The calculation unit 337c calculates the time required for the customer to go around the commercial facility along the guide route 362 generated by the generation unit 337b, that is, the stay time in the commercial facility. When calculating the stay time, the calculation unit 337c refers to the customer segment and the average stay time for each customer segment of each store. The customer segment is obtained from the user management record 351. The average stay time for each customer segment is obtained from the store management record 341. The average stay time for each customer segment can be the estimated stay time of the customer at the store. The calculation unit 337c calculates the stay time in the commercial facility by adding up the average stay time of the corresponding customer segment of each store included in the guide route 362 and further adding a travel time thereto. The travel time is the time required for the customer to move between the stores along the guide route 362. In the auxiliary storage device 333, the time required for movement between the stores is set in advance such as, for example, “the travel time between a store A and a store B is 3 minutes”.

The determination unit 337d calculates a difference between the stay time in the commercial facility calculated by the calculation unit 337c and the scheduled stay time of the customer, and determines whether the difference therebetween exceeds a threshold time. When the difference therebetween exceeds the threshold time, the determination unit 337d instructs the generation unit 337b to change the guide route 362. The scheduled stay time of the customer is obtained from the route management record 361. The threshold time is set in the auxiliary storage device 333 in advance. The different threshold time may be set depending on whether the stay time exceeds or falls below the scheduled stay time of the customer.

The generation unit 337b receiving the change instruction of the guide route 362 regenerates the guide route 362. At this time, when the stay time exceeds the scheduled stay time of the customer, the generation unit 337b regenerates the guide route 362 by sequentially excluding stores corresponding to the purpose of low priority order so that the stores having high priority order are visited preferentially. However, when all the stores corresponding to the purpose of the low priority order are excluded, when there are a plurality of stores corresponding to the purpose of the higher priority order than that, the generation unit 337b regenerates the guide route 362 by excluding one of the stores corresponding to the purpose of the high priority order. That is, the generation unit 337b regenerates the guide route 362 while leaving the store corresponding to the purpose of the lower priority order. When the stay time falls below the scheduled stay time of the customer, the generation unit 337b regenerates the guide route 362 by adding a new store or common facility. A coffee shop, a park, and a rest facility can be considered as the new store or the common facility.

The calculation unit 337c calculates the stay time in the commercial facility by the guide route 362 regenerated by the generation unit 337b. The determination unit 337d determines whether or not the difference between the stay time in the commercial facility calculated by the calculation unit 337c and the scheduled stay time of the customer exceeds the threshold time. When the difference therebetween exceeds the threshold time, the determination unit 337d instructs the generation unit 337b to change the route again.

Thereafter, the generation unit 337b, the calculation unit 337c, and the determination unit 337d repeat the above-described processing until the difference between the stay time in the commercial facility by the guide route 362 and the scheduled stay time of the customer falls within the range of the threshold time. Next, when the guide route 362, in which the difference between the stay time in the commercial facility and the scheduled stay time of the customer falls within the range of the threshold time, is generated, the determination unit 337d instructs the editing unit 337e to edit the guide route 362. The editing unit 337e receiving this instruction edits the time and the stay time corresponding to each place in the order of the guide route 362 with reference to the average stay time for each customer segment and the travel time between the stores used in the calculation unit 337c.

The output unit 337f outputs the data of the guide route 362 edited by the editing unit 337e to the processor 331. Upon receiving this output, the processor 331 overwrites and stores the data of the guide route 362 in the corresponding route management record 361.

Thus, the store search unit 336 and the route search unit 337 search for the highly efficient guide route 362 based upon the purpose of the customer visiting the commercial facility and the condition related to the purpose. In other words, the highly efficient guide route 362 is searched for even when the commodity to be purchased is not determined. Then, the route management record 361 including the data of the guide route 362 is stored in the route database 36 and provided for the route guide service.

Here, the store search unit 336 sets the purpose of the customer who is a user in the commercial facility and a plurality of conditions related to the purpose as input data, and sets the business type or the business category of each store opening in the commercial facility as reference data, thereby functioning as a store search unit that searches for the store matching the purpose. Further, the route search unit 337 sets the store searched for by the store search unit 336 and the scheduled stay time of the customer in the commercial facility as input data, and sets the layout of the commercial facility and the estimated stay time at the store as reference data, thereby functioning as a route generation unit that generates the guide route for going around the store within the scheduled stay time. Particularly, the route search unit 337 includes the priority order of the purpose as the input data, and generates the guide route for preferentially going around the stores having the high priority order. Further, the route search unit 337 includes the final destination of the route as the reference data, and generates the guide route for going around the store and arriving at the final destination within the scheduled stay time.

Next, the processor 331 of the route search server 33 will be described.

FIGS. 11 to 15 are flowcharts illustrating a procedure of main information processing executed by the processor 331 of the route search server 33. The processor 331 executes the information processing according to the control program stored in the main memory 332 or the auxiliary storage device 333. Further, the procedure of the information processing is not limited thereto. As long as the same result can be obtained, the procedure of the information processing can be implemented with various modifications.

As illustrated in FIG. 11, the processor 331 waits for a command as ACT 1. When receiving the command via the communication interface 335, the processor 331 identifies the type of the command from data obtained by analyzing the command as ACT 2.

Here, commands received by the route search server 33 in the embodiment include an activation command, an end command, a store entry command, and a store exit command. The activation command is transmitted from the user terminal 1 in which the route guide program is activated and the communication line with the server system 3 is established. The end command is transmitted from the user terminal 1 in which the route guide program is stopped. The store entry command is transmitted from the store entry and exit detection system 2 that detects a store entry. The store exit command is transmitted from the store entry and exit detection system 2 that detects a store exit. The activation command and the end command include the user ID set in the user terminal 1 of a command transmission source. The store entry command and the store exit command include the store ID of the store in which the store entry and exit detection system 2 of a command transmission source is configured.

The processor 331 confirms whether or not the activation command is received as ACT 3. When the activation command is not received, the processor 331 determines NO in ACT 3 and proceeds to ACT 4. The processor 331 determines whether or not the store entry command is received as ACT 4. When the store entry command is not received, the processor 331 determines NO in ACT 4 and proceeds to ACT 5. The processor 331 determines whether or not the store exit command is received as ACT 5. When the store exit command is not received, the processor 331 determines NO in ACT 5 and proceeds to ACT 6. The processor 331 determines whether or not the end command is received as ACT 6. When the end command is not received, the processor 331 determines NO in ACT 6 and executes another command reception processing.

When the received command is the activation command, the processor 331 determines YES in ACT 3 and proceeds to ACT 7. The processor 331 executes reception processing as ACT 7. Further, hereinafter, the user terminal 1 of an activation command transmission source is represented as a user terminal 1A.

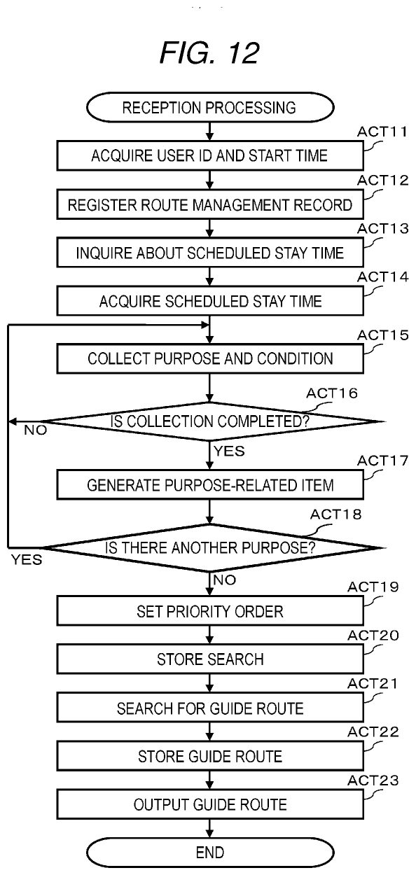

FIG. 12 is a flowchart specifically illustrating a procedure of the reception processing. When performing the reception processing, the processor 331 acquires the user ID from the activation command as ACT 11. Further, the processor 331 acquires the time counted by the clock 334 as the start time. Next, the processor 331 generates the route management record 361 in which the user ID and the start time are set as ACT 12, and registers the generated route management record 361 in the route database 36. Hereinafter, the route management record 361 registered in the route database 36 by the processing of ACT 12 is represented as a route management record 361A.

The processor 331 inquires of the user terminal 1A of the activation command transmission source about the scheduled stay time as ACT 13. In response to this inquiry, in the user terminal 1A, for example, since an image for urging a customer who is a user to input the scheduled stay time is displayed on a display device, the customer inputs the scheduled stay time by operating an input device. The processor 331 acquires the scheduled stay time from the user terminal 1A as ACT 14, and describes the acquired scheduled stay time in the route management record 361A.

The processor 331 collects a purpose and a condition from the user terminal 1A in an interactive manner as ACT 15. For example, the processor 331 first inquires of the user terminal 1A about the purpose of visiting the commercial facility. In response to this inquiry, in the user terminal 1A, for example, since an image for inquiring about “What is the purpose of visiting the commercial facility?” is displayed on the display device, the customer inputs the purpose via the input device. When the processor 331 acquires the purpose from the user terminal 1A, the processor 331 inquires of the user terminal 1A about the condition related to the purpose.

For example, when the purpose is “I want to buy a present for Father's Day”, the processor 331 inquires about the age of his or her father as a condition. In response to this inquiry, in the user terminal 1A, for example, since an image for inquiring about “How old is your father?” is displayed on the display device, the customer inputs the age of his or her father via the input device. When the processor 331 acquires the age of his or her father as the condition from the user terminal 1A, the processor 331 proceeds to ACT 16.

The processor 331 confirms whether or not the collection of conditions for one purpose is completed as ACT 16. When the purpose is “I want to purchase a present for Father's Day”, the conditions therefor include a hobby and a preference of his or her father other than father's age. Therefore, the processor 331 determines NO in ACT 16 and returns to ACT 15. The processor 331 inquires of the customer about the hobby or preference of his or her father. In the user terminal 1A, since an image for urging the customer to input the hobby or preference of his or her father is displayed on the display device, the customer inputs the hobby or preference of his or her father as much as possible via the input device. When the processor 331 acquires the hobby or preference of his or her father as the conditions from the user terminal 1A, the processor 331 proceeds to ACT 16.

In this manner, when the collection of conditions for one purpose is completed, the processor 331 determines YES in ACT 16 and proceeds to ACT 17. The processor 331 generates purpose-related item data based upon the information acquired from the user terminal 1A as ACT 17 and describes the generated purpose-related item data in the route management record 361A. Further, the priority order is not set in the purpose-related item data at this time. Further, the achievement flag is set to “0” indicating non-achievement.

When the processing of ACT 17 is completed, the processor 331 inquires whether or not there is another purpose of visiting the commercial facility as ACT 18. In response to this inquiry, in the user terminal 1A, for example, since an image for inquiring about “Is there another purpose?” is displayed on the display device, the customer inputs the presence or absence of the purpose via the input device. When there is another purpose, the processor 331 determines YES in ACT 18 and returns to ACT 15. Next, the processor 331 collects another purpose and condition from the user terminal 1A in an interactive manner. As a result, the purpose-related item data for the new purpose are generated and described in the route management record 361A.

When receiving a notification from the user terminal 1A that there is no another purpose, the processor 331 determines NO in ACT 18 and proceeds to ACT 19. The processor 331 instructs the user terminal 1A to set the priority order of the purpose as ACT 19. In response to this instruction, in the user terminal 1A, for example, since an image for indicating an instruction that “Please set the priority order of the purpose” is displayed on the display device, the customer inputs the priority order of the purpose via the input device. Next, when the priority order is inputted, the processor 331 respectively sets the priority order to each of the purpose-related item data described in the route management record 361A.

Further, the collection of the purpose and condition, and the setting of the priority order in the interactive manner as described above can be performed by using the technology of the existing AI robot.

When the processing of ACT 11 to ACT 19 is completed in this manner, the processor 331 instructs the store search unit 336 to execute a store search as ACT 20. In response to this instruction, as described above, the store search unit 336 searches for the recommended store. When the recommended store is searched for, the processor 331 instructs the route search unit 337 to perform a route search as ACT 21. In response to this instruction, the route search unit 337 performs the route search and outputs data of the guide route 362.

The processor 331 describes the data of the guide route 362 in the route management record 361A as ACT 22. Further, the processor 331 controls the communication interface 335 so as to output the data of the guide route 362 to the user terminal 1A as ACT 23. As described above, the processor 331 ends the reception processing.

By executing the above-described reception processing, the data of the guide route 362 are transmitted from the route search server 33 to the user terminal 1A via the network 4. In the user terminal 1A receiving the data thereof, the guide route is displayed on the display device according to the route guide program.

Refer back to the description of FIG. 11.

When the received command is the store entry command, the processor 331 determines YES in ACT 4 and proceeds to ACT 8. The processor 331 executes store entry processing as ACT 8. Further, hereinafter, the user terminal 1 of a store entry command transmission source is represented as a user terminal 1B.

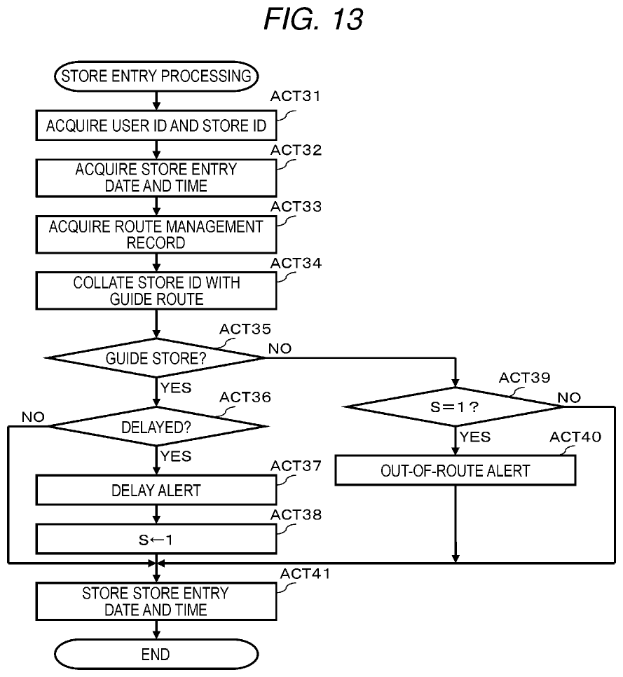

FIG. 13 is a flowchart specifically illustrating a procedure of the store entry processing. When performing the store entry processing, the processor 331 acquires the user ID and the store ID from the store entry command as ACT 31. Further, the processor 331 acquires the date and time counted by the clock 334 as the store entry date and time as ACT 32.

The processor 331 searches the route database 36 as ACT 33, and acquires the route management record 361 in which the user ID acquired from the store entry command is set. Hereinafter, the route management record 361 in which the user ID acquired from the store entry command is set is represented as a route management record 361B.

The processor 331 collates the store ID acquired from the store entry command with the guide route 362 of the route management record 361B as ACT 34. Next, the processor 331 confirms whether or not the store identified by the store ID is one of the stores guided by the guide route 362. Specifically, the processor 331 confirms whether or not the store ID is included in the place data of the guide route 362.

When the store ID is included in the place data of the guide route 362, the store identified by the store ID is a guide store. In this case, the processor 331 determines YES in ACT 35 and proceeds to ACT 36. The processor 331 compares the time correlated with the place data including the store ID in the guide route 362 with the time of the store entry date and time acquired by the processing of ACT 32 as ACT 36. Next, the processor 331 confirms whether or not the time acquired from the guide route 362 is delayed by a predetermined time or more than the time of the store entry date and time. The predetermined time is optional. For example, 15 minutes is fixedly set as the predetermined time. The predetermined time may be set to be shorter as the remaining time until the scheduled stay time becomes shorter. For example, when the remaining time until the scheduled stay time is 2 hours or more, the predetermined time may be set to 20 minutes; when the remaining time is 1 hour or more and less than 2 hours, the predetermined time may be set to 10 minutes; and when the remaining time is less than 1 hour, the predetermined time may be set to 5 minutes. Further, the above-described time is merely an example.

When the delay of the predetermined time does not occur, the processor 331 determines NO in ACT 36 and proceeds to ACT 41. The processing of ACT 41 will be described later.

In contrast, when the predetermined time delay occurs, the processor 331 determines YES in ACT 36 and proceeds to ACT 37. The processor 331 controls the communication interface 335 so as to transmit a delay alert command to the user terminal 1B as ACT 37. By this control, the delay alert command is transmitted from the communication interface via the network 4. The command includes the user ID obtained from the store entry command. The delay alert command is wirelessly transmitted via the access point 41, and is received by the user terminal 1B in which the user ID in the command is set. Thus, the user terminal 1B outputs a delay alert for notifying the customer of being behind the guide route. The delay alert may be outputted by a display or may be outputted by a voice.

The processor 331 that controls the command transmission of the delay alert sets an alert status of the route management record 361B to “1” as ACT 38. Then, the processor 331 proceeds to ACT 41. Here, the alert status stores a state where the delay alert occurs as data “1”.

On the other hand, when the store ID is not included in the place data of the guide route 362, the store identified by the store ID is not the guide store. In this case, the processor 331 determines NO in ACT 35 and proceeds to ACT 39. The processor 331 confirms whether or not the alert status S of the route management record 361B is set to “1” as ACT 39. When the alert status S is not set to “1”, the delay alert does not occur. In this case, the processor 331 determines NO in ACT 39 and proceeds to ACT 41.

In contrast, when the alert status S is set to “1”, the delay alert occurs before the customer reaches the guide store. In this case, the processor 331 determines YES in ACT 39 and proceeds to ACT 40. The processor 331 controls the communication interface 335 so as to transmit an out-of-route alert command to the user terminal 1B as ACT 40. By this control, the out-of-route alert command is transmitted from the communication interface 335 via the network 4. The command includes the user ID obtained from the store entry command. The out-of-route alert command is wirelessly transmitted via the access point 41, and is received by the user terminal 1B in which the user ID in the command is set. Thus, the user terminal 1B outputs an out-of-route alert for notifying the customer of being out of the guide route. The out-of-route alert may be outputted by a display or may be outputted by a voice. The processor 331 that controls the command transmission of the out-of-route alert proceeds to ACT 41.

The processor 331 describes the store entry date and time acquired by the processing of ACT 32 in the route management record 361B as ACT 41. As described above, the processor 331 ends the store entry processing.

Refer back to the description of FIG. 11.

When the received command is the store exit command, the processor 331 determines YES in ACT 5 and proceeds to ACT 9. The processor 331 executes store exit processing as ACT 9. Further, hereinafter, the user terminal 1 of a store exit command transmission source is referred to as a user terminal 1C.

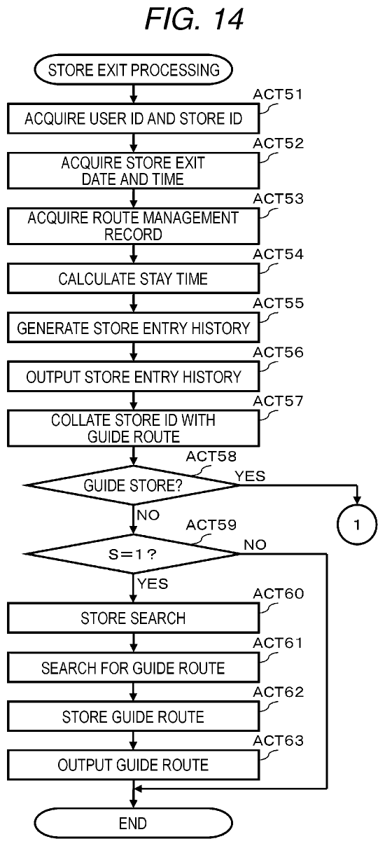

FIG. 14 is a flowchart specifically illustrating a procedure of the store exit processing. When performing the store exit processing, the processor 331 acquires the user ID and the store ID from the store exit command as ACT 51. In addition, the processor 331 acquires the date and time counted by the clock 334 as the store exit date and time as ACT 52.

The processor 331 searches the route database 36 as ACT 53, and acquires the route management record 361 in which the user ID acquired from the store exit command is set. Hereinafter, the route management record 361 in which the user ID acquired from the store exit command is set is represented as a route management record 361C.

The processor 331 acquires the store entry date and time from the route management record 361C as ACT 54, and calculates the elapsed time from the store entry date and time to the store exit date and time as the stay time. Next, the processor 331 generates the store entry history as ACT 55. That is, the processor 331 generates the store entry history with the store ID acquired by the processing of ACT 51 and the store entry date and time and the stay time acquired by the processing of ACT 54. The processor 331 outputs the store entry history to the user management server 32 together with the user ID acquired by the processing of ACT 51 as ACT 56. The user management server 32 adds the store entry history to the user management record 351 in which the user ID is set.

The processor 331 collates the store ID acquired from the store exit command with the guide route 362 of the route management record 361C as ACT 57. Next, the processor 331 confirms whether or not the store identified by the store ID is one of the stores guided by the guide route 362. Specifically, the processor 331 confirms whether or not the store ID is included in the place data of the guide route 362.

When the store ID is not included in the place data of the guide route 362, the store identified by the store ID is not the guide store. In this case, the processor 331 determines NO in ACT 58 and proceeds to ACT 59. The processor 331 confirms whether or not the alert status S of the route management record 361C is set to “1” as ACT 59. When the alert status S is not set to “1”, the delay alert does not occur. In this case, the processor 331 determines NO in ACT 59 and ends the store exit processing.

In contrast, when the alert status S is set to “1”, the delay alert occurs. In this case, the processor 331 determines YES in ACT 59 and proceeds to ACT 60. Thereafter, the processor 331 executes the same processing as that of ACT 19, ACT 20, ACT 21, and ACT 22 described above as ACT 60, ACT 61, ACT 62, and ACT 63.

That is, the processor 331 instructs the store search unit 336 to execute a store search as ACT 60. In response to this instruction, the store search unit 336 searches for the recommended store. When the recommended store is searched for, the processor 331 instructs the route search unit 337 to perform a route search as ACT 61. In response to this instruction, the route search unit 337 performs the route search and outputs data of the guide route 362. The processor 331 describes the data of the guide route 362 in the route management record 361C as ACT 62. Further, the processor 331 controls the communication interface 335 so as to output the data of the guide route 362 to the user terminal 1C as ACT 63. As described above, the processor 331 ends the store exit processing.

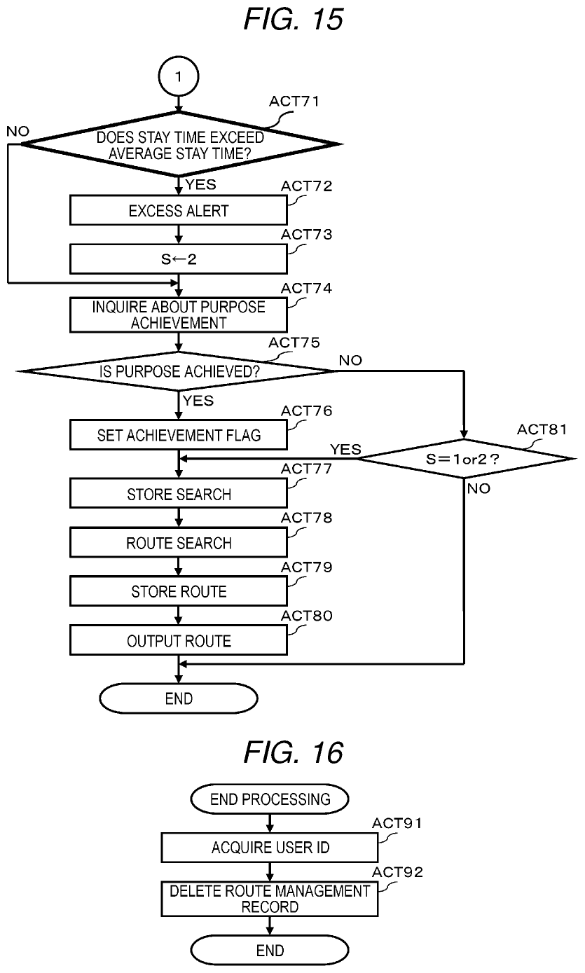

On the other hand, when the store ID is included in the place data of the guide route 362, the store identified by the store ID is the guide store. In this case, the processor 331 determines YES in ACT 58 and proceeds to ACT 71 of FIG. 15. The processor 331 confirms whether or not the stay time exceeds the scheduled stay time of the guide store as ACT 71. That is, the processor 331 compares the average stay time correlated with the place data including the store ID in the guide route 362 with the stay time calculated by the processing of ACT 54. Next, the processor 331 confirms whether or not the stay time exceeds the average stay time by a predetermined time or more. The predetermined time is optional. For example, 15 minutes is fixedly set as the predetermined time. The predetermined time may be set to be shorter as the remaining time until the scheduled stay time becomes shorter. For example, when the remaining time until the scheduled stay time is 2 hours or more, the predetermined time may be set to 20 minutes; when the remaining time is 1 hour or more and less than 2 hours, the predetermined time may be set to 10 minutes; and when the remaining time is less than 1 hour, the predetermined time may be set to 5 minutes. Further, the above-described time is merely an example.

When the stay time does not exceed the average stay time by the predetermined time or more, the processor 331 determines NO in ACT 71 and proceeds to ACT 74. The processing of ACT 74 will be described later.

In contrast, when the stay time exceeds the average stay time by the predetermined time or more, the processor 331 determines YES in ACT 71 and proceeds to ACT 72. The processor 331 controls the communication interface 335 so as to transmit an excess alert command to the user terminal 1C as ACT 72. By this control, the excess alert command is transmitted from the communication interface 335 via the network 4. The command includes the user ID obtained from the store exit command. The excess alert command is wirelessly transmitted via the access point 41, and is received by the user terminal 1C in which the user ID in the command is set. Thus, the user terminal 1C outputs an excess alert for notifying the customer that the stay time at the guide store exceeds the scheduled stay time. The excess alert may be outputted by a display or may be outputted by a voice.

The processor 331 that controls the command transmission of the excess alert sets an alert status of the route management record 361C to “2” as ACT 73. Next, the processor 331 proceeds to ACT 74. Here, the alert status stores a state where the excess alert occurs as data “2”.

The processor 331 inquires of the user terminal 1C of the store exit command transmission source whether or not the purpose of visiting the commercial facility is achieved as ACT 74. In response to this inquiry, in the user terminal 1C, an image for urging the customer who is a user to input whether or not the purpose of visiting the commercial facility is achieved is displayed on the display device. Next, the customer determines whether or not the purpose is achieved, and performs an input indicating the determination result to the input device. After receiving this input, the processor 331 confirms whether or not the purpose is achieved as ACT 75.

When the purpose is achieved, the processor 331 determines YES in ACT 75 and proceeds to ACT 76. The processor 331 sets an achievement flag of a related item whose purpose is achieved among the related items for each purpose of the route management record 361C to “1” as ACT 76. Thereafter, the processor 331 executes the same processing as that of ACT 60, ACT 61, ACT 62, and ACT 63 described above as ACT 77, ACT 78, ACT 79, and ACT 80.

That is, the processor 331 instructs the store search unit 336 to execute the store search as ACT 77. In response to this instruction, the store search unit 336 searches for the recommended store. However, in this case, the purpose, the condition, and the priority order of the related item for each purpose in which the achievement flag is set to “1” are excluded. When the recommended store is searched for, the processor 331 instructs the route search unit 337 to perform a route search as ACT 77. In response to this instruction, the route search unit 337 performs the route search and outputs data of the guide route 362. The processor 331 describes the data of the guide route 362 in the route management record 361C as ACT 79. Further, the processor 331 controls the communication interface 335 so as to output the data of the guide route 362 to the user terminal 1C as ACT 80. As described above, the processor 331 ends the store exit processing.

On the other hand, when the purpose is not achieved, the processor 331 determines NO in ACT 75 and proceeds to ACT 81. The processor 331 confirms whether or not the alert status S of the route management record 361C is set to “1” or “2” as ACT 81. When the alert status S is not set to “1” or “2”, the processor 331 determines NO in ACT 81 and ends the store exit processing.

In contrast, when the alert status S is set to “1” or “2”, the processor 331 determines YES in ACT 81 and proceeds to ACT 77. The processor 331 executes the same processing as that of ACT 60, ACT 61, ACT 62, and ACT 63 as ACT 77, ACT 78, ACT 79, and ACT 80.

Refer back to the description of FIG. 11.

When the received command is the end command, the processor 331 determines YES in ACT 6 and proceeds to ACT 10. The processor 331 executes end processing as ACT 10.

FIG. 16 is a flowchart specifically illustrating a procedure of the end processing. When performing the end processing, the processor 331 acquires the user ID from the end command as ACT 91. Next, the processor 331 searches the route database 36 as ACT 92, and deletes the route management record 361 in which the user ID acquired by the processing of ACT 91 is set. As described above, the processor 331 ends the end processing.

Further, the deletion of the route management record 361 indicates physically deleting the route management record 361 from the route database 36. Alternatively, a deletion flag may be added to the route management record 361 and left in the route database 36 as one substantially deleted.

Here, a computer of the route search server 33 including the processor 331 as a main body configures a collection unit by executing the processing of ACT 15 to ACT 18 in FIG. 12 in cooperation with the communication interface 335. That is, the computer collects the purpose in the commercial facility and a plurality of conditions related to the purpose from the user terminal 1.

The computer of the route search server 33 configures an output unit by executing the processing of ACT 23 in FIG. 12 in cooperation with the communication interface 335. That is, the computer outputs the data of the guide route 362 generated by a route generation unit to the user terminal 1.

The computer of the route search server 33 configures an inquiry unit by executing the processing of ACT 74 and ACT 75 in FIG. 15 in cooperation with the communication interface 335. That is, the computer inquires of the customer using the user terminal 1 which is a data output destination of the guide route 362 whether or not the purpose is achieved at the timing of exiting the store guided by the guide route 362, and then receives a response to the inquiry. When receiving the response that the purpose is achieved as a result of the inquiry, the computer executes the processing of ACT 76 to ACT 80 in FIG. 15. That is, the computer re-executes the search for stores except the stores matching the purpose and the generation of the guide route for going around the searched stores.

The computer of the route search server 33 configures a notification unit by executing the processing of ACT 71 and ACT 72 in FIG. 15 in cooperation with the communication interface 335. That is, with respect to the customer using the user terminal 1 which is the data output destination of the guide route 362, when the stay time at the store guided by the guide route 362 exceeds the estimated stay time at the store, the computer notifies the user terminal 1 of the excess alert. Next, when the stay time exceeds the estimated stay time, that is, when the alert status S is set to “2”, the computer executes the processing of ACT 76 to ACT 80 in FIG. 15. That is, the computer re-executes the generation of the guide route.

As described above, according to the embodiment, even when a commodity to be purchased is not determined, it is possible to provide a route search apparatus capable of searching for the highly efficient guide route 362 from the purpose of a customer visiting a commercial facility and a condition related to the purpose. In this case, it is possible to search for the guide route 362 for preferentially going around a store having a high priority order of the purpose. Further, it is possible to search for the guide route 362 for reaching a final destination desired by a customer within the scheduled stay time desired by the customer. Further, there may be a plurality of purposes. When one of the purposes is achieved, it is possible to search for the guide route 362 excluding a store matching the achieved purpose. Further, when the scheduled stay time at the store stopped by the guide route 362 exceeds the estimated stay time, an alert is issued to warn the customer of the excess of the stay time.

### Second Embodiment

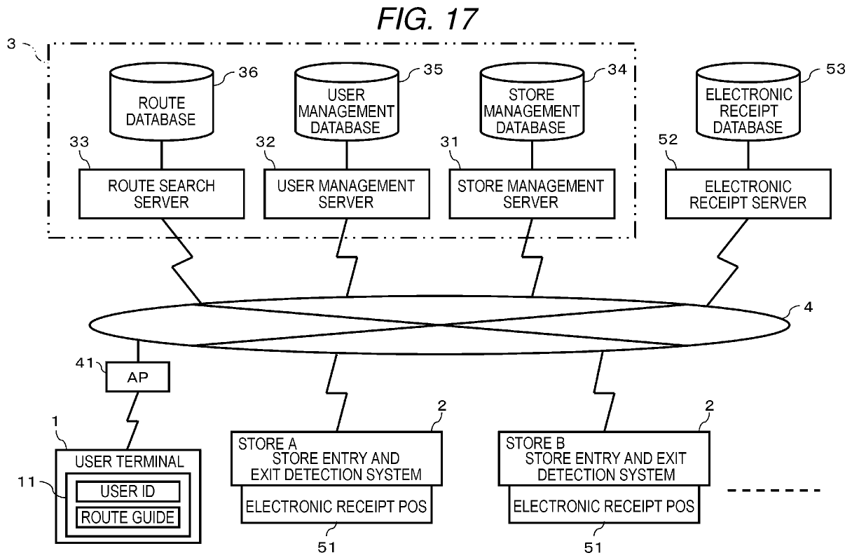

FIG. 17 is a schematic diagram illustrating a system configuration of a second embodiment. In the second embodiment, an electronic receipt system is incorporated into the system of the first embodiment. The electronic receipt system is a system for dispensing a digitalized electronic receipt without printing a receipt to be generated at the time of settlement of a customer who purchases a commodity at each store on a paper medium and dispensing the printed receipt. The electronic receipt system is configured by POS terminals 51 for the electronic receipt, which are provided in each store and an electronic receipt server 52. Each of the POS terminals 51 and the electronic receipt server 52 are connected to the network 4.

The POS terminal 51 has a function of registering and processing sales data of commodities purchased by a customer and a function of settling a commercial transaction based upon the registered and processed sales data of the commodities. Further, the POS terminal 51 includes a reading unit that reads an electronic receipt ID which is an identification code of a customer who receives a receipt with the electronic receipt. Next, when reading the electronic receipt ID by the reading unit, the POS terminal 51 transmits data of the electronic receipt generated at the time of the settlement together with the electronic receipt ID to the electronic receipt server 52 via the network 4.

The electronic receipt server 52 includes an electronic receipt database 53 for storing the data of the electronic receipt. The electronic receipt database 53 may be formed in a storage device incorporated in the electronic receipt server 52, or may be formed in a storage device connected to the outside of the electronic receipt server 52.

The electronic receipt server 52 stores the data of the electronic receipt received from each POS terminal 51 in the electronic receipt database 53 in correlation with the electronic receipt ID. As described above, the data of the electronic receipt stored in the electronic receipt database 53 in correlation with the electronic receipt ID are downloaded to an information terminal such as a smartphone, a tablet terminal, and a notebook type personal computer specified by the electronic receipt ID, and the customer can browse the data thereof.

In the second embodiment, the user ID being set in the user terminal 1 is linked with the electronic receipt ID of the customer who is a user of the user terminal 1. Accordingly, when the customer who is the user of the user terminal 1 purchases a commodity at a store in a commercial facility, the data of the electronic receipt can be downloaded to the user terminal 1 and can be viewed therefrom.

In the second embodiment in which such an electronic receipt system is incorporated, the processor 331 of the route search server 33 changes the processing of ACT 74 in the store exit processing from the first embodiment.

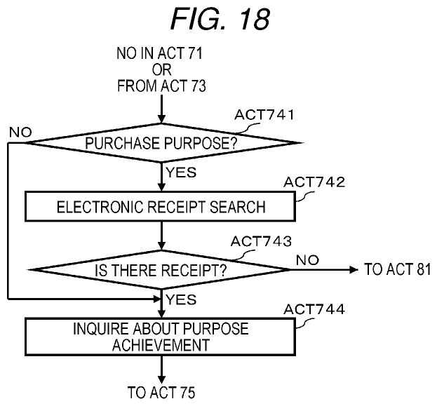

FIG. 18 is a flowchart illustrating a part of the store exit processing in which the processing of ACT 74 of the first embodiment is changed. That is, when NO is determined in ACT 71 of FIG. 15 or the processing of ACT 73 is completed, the processor 331 confirms whether or not a customer exits the store for the purpose of purchase as ACT 741. That is, the processor 331 confirms whether or not the purpose of a purpose-related item is a purpose accompanied by the purchase of the commodity. Here, when the customer exits a store where the purpose of the purpose-related item is not the purpose accompanied by the purchase of the commodity, that is, which is not for the purpose of purchase, the processor 331 determines NO as ACT 741 and proceeds to ACT 744. The processing of ACT 744 will be described later.

In contrast, when the customer exits the store where the purpose of the purpose-related item is the purpose accompanied by the purchase of the commodity, that is, which is for the purpose of purchase, the processor 331 determines YES as ACT 741 and proceeds to ACT 742. As ACT 742, the processor 331 sends a notification to the electronic receipt server 52 so as to search the electronic receipt dispensed by the electronic receipt ID linked to the user ID acquired by the processing of ACT 51 from the POS terminal 51 of the store where the customer exits. The electronic receipt server 52 receiving this notification confirms whether or not the electronic receipt data of the corresponding electronic receipt ID are received from the POS terminal 51. When the electronic receipt data are received therefrom, the electronic receipt server 52 notifies the user terminal 1 of a response indicating that there is the electronic receipt. When the electronic receipt data are not received therefrom, the electronic receipt server 52 notifies the user terminal 1 of a response indicating that there is no electronic receipt.

The processor 331 waits for the response from the electronic receipt server 52 as ACT 743. When receiving the response indicating that there is no electronic receipt, the processor 331 determines NO in ACT 743 and proceeds to the processing of ACT 81 in FIG. 15.

In contrast, when receiving the response indicating that there is the electronic receipt, the processor 331 determines YES in ACT 743 and proceeds to ACT 744. The processor 331 inquires of the user terminal 1C of the store exit command transmission source whether or not the purpose of visiting the commercial facility is achieved as ACT 744. Next, the processor 331 proceeds to the processing of ACT 75 in FIG. 15.

As described above, in the second embodiment, when the customer exits the store for the purpose of purchase, whether or not the purpose is achieved on the condition that the commodity is purchased at the store is configured to be inquired. In other words, when the customer exits the store for the purpose of purchase without purchasing the commodity, whether or not the purpose is achieved is not configured to be inquired. Accordingly, since a useless inquiry does not occur, the load on the route search server 33 can be reduced. Further, even the customer who is the user does not feel troublesome.

As described above, the embodiment of the route search apparatus capable of searching for the highly efficient route from the purpose of the customer visiting the commercial facility is described, but the embodiment is not limited thereto.

In the above-described embodiment, the case, in which the generation unit 337b generates the guide route 362 from the current position to the final destination through each store according to the rule that the travel distance becomes minimum, is described. The rule for generating the guide route 362 is not limited to the above-described rule. For example, when there is a crowded time zone depending on a store, the guide route 362 may be generated avoiding the time zone. Further, when there are a plurality of stores for the purpose of purchase, when one store performs a special sale, the guide route 362 may be generated so that the store performing the special sale may be visited preferentially.

In the embodiment, the travel time between the stores used by the calculation unit 337c is set to be the fixed time. In general, a walking speed varies depending on a person. Therefore, the stay time in the commercial facility may be calculated by setting the walking speed by the customer himself or herself and correcting the travel time based upon the set speed.

In the embodiment, when the customer exits the guide store, the customer is inquired as to whether or not the purpose is achieved. The timing for inquiring whether or not the purpose is achieved is not limited to the time the customer exits the guide store. For example, whether or not the purpose is achieved may be regularly inquired to the customer.

In the embodiment, as a method for collecting the purpose and condition from the user terminal 1 in an interactive manner, an image is displayed on the display device of the user terminal 1 and the purpose and the condition are inputted via the input device. With respect to this point, the purpose and the condition may be collected by using a voice on the assumption that the user terminal 1 includes a voice recognition device.

In the embodiment, it is configured that the customer inputs the final destination together with the scheduled stay time. Depending on the commercial facility, the final destination may be unambiguously determined. In such a case, the input of the final destination can be omitted.

In the embodiment, the server system 3 is configured by the store management server 31, the user management server 32, and the route search server 33. The servers constituting the server system 3 are not limited to the three servers described above. For example, one server may have functions of three servers.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A route search apparatus, comprising:
a store search component configured to search for a store matching a purpose by setting the purpose of a user in a commercial facility and a plurality of conditions related to the purpose as input data, and by setting a business type or a business category of each store opening in the commercial facility as reference data; and
a route generation component configured to generate a guide route for going around the store within a scheduled stay time by setting the store searched by the store search component and the scheduled stay time of the user in the commercial facility as input data, and by setting a layout of the commercial facility and an estimated stay time at the store as reference data.

2. The apparatus according to claim 1, wherein
the route generation component comprises priority order of the purpose as the input data, and generates the guide route for preferentially going around a store having a high priority order.

3. The apparatus according to claim 1, wherein
the route generation component comprises a final destination of a route as the reference data, and generates the guide route for going around the store and reaching the final destination within the scheduled stay time.

4. The apparatus according to claim 1, further comprising:
a collection component configured to collect the purpose in the commercial facility and the plurality of conditions related to the purpose from a terminal used by the user; and
an output component configured to output data of the guide route generated by the route generation component to the terminal.

5. The apparatus according to claim 4, further comprising:
an inquiry component configured to inquire of the user using the terminal which is a data output destination of the guide route whether or not the purpose is achieved at the timing of exiting a store guided by the guide route or periodically, and to receive a response to the inquiry, wherein
as a result of the inquiry, when the response indicating that the purpose is achieved is received, the store search component and the route generation component re-execute a search for a store excluding the store matching the purpose and generation of a guide route for going around the searched store.

6. The apparatus according to claim 4, further comprising:
a notification component configured to notify the terminal of an alert when a stay time at a store guided by the guide route exceeds an estimated stay time at the store, with respect to the user using the terminal which is a data output destination of the guide route.

7. The apparatus according to claim 4, wherein the terminal is a smart phone.

8. A route search method, comprising:
searching for a store matching a purpose by setting the purpose of a user in a commercial facility and a plurality of conditions related to the purpose as input data, and by setting a business type or a business category of each store opening in the commercial facility as reference data; and
generating a guide route for going around the store within a scheduled stay time by setting the store searched and the scheduled stay time of the user in the commercial facility as input data, and by setting a layout of the commercial facility and an estimated stay time at the store as reference data.

9. The method according to claim 8, wherein
guide route generating comprises priority order of the purpose as the input data, further comprising:
generating the guide route for preferentially going around a store having a high priority order.

10. The method according to claim 8, wherein
guide route generating comprises a final destination of a route as the reference data, further comprising:
generating the guide route for going around the store and reaching the final destination within the scheduled stay time.

11. The method according to claim 8, further comprising:
collecting the purpose in the commercial facility and the plurality of conditions related to the purpose from a terminal used by the user; and
outputting data of the guide route generated to the terminal.

12. The method according to claim 11, further comprising:
inquiring of the user using the terminal which is a data output destination of the guide route whether or not the purpose is achieved at the timing of exiting a store guided by the guide route or periodically, and to receive a response to the inquiry; and
as a result of the inquiry, when the response indicating that the purpose is achieved is received, re-executing a search for a store excluding the store matching the purpose and generation of a guide route for going around the searched store.

13. The method according to claim 11, further comprising:
notifying the terminal of an alert when a stay time at a store guided by the guide route exceeds an estimated stay time at the store, with respect to the user using the terminal which is a data output destination of the guide route.

14. The method according to claim 11, wherein the terminal is a smart phone.

15. A non-transitory computer readable storage medium that stores a computer program to be executed by a computer to perform at least:
searching for a store matching a purpose by setting the purpose of a user in a commercial facility and a plurality of conditions related to the purpose as input data, and by setting a business type or a business category of each store opening in the commercial facility as reference data; and
generating a guide route for going around the store within a scheduled stay time by setting the store searched and the scheduled stay time of the user in the commercial facility as input data, and by setting a layout of the commercial facility and an estimated stay time at the store as reference data.

16. The non-transitory computer storage medium according to claim 15, wherein
guide route generating comprises priority order of the purpose as the input data, the computer further performing:
generating the guide route for preferentially going around a store having a high priority order.

17. The non-transitory computer storage medium according to claim 15, wherein
guide route generating comprises a final destination of a route as the reference data, the computer further performing:
generating the guide route for going around the store and reaching the final destination within the scheduled stay time.

18. The non-transitory computer storage medium according to claim 15, the computer further performing:
collecting the purpose in the commercial facility and the plurality of conditions related to the purpose from a terminal used by the user; and
outputting data of the guide route generated to the terminal.

19. The non-transitory computer storage medium according to claim 18, the computer further performing:
inquiring of the user using the terminal which is a data output destination of the guide route whether or not the purpose is achieved at the timing of exiting a store guided by the guide route or periodically, and to receive a response to the inquiry; and
as a result of the inquiry, when the response indicating that the purpose is achieved is received, re-executing a search for a store excluding the store matching the purpose and generation of a guide route for going around the searched store.

20. The non-transitory computer storage medium according to claim 18, the computer further performing:
notifying the terminal of an alert when a stay time at a store guided by the guide route exceeds an estimated stay time at the store, with respect to the user using the terminal which is a data output destination of the guide route.
